(19) United States
(12) Patent Application Publication
(10) Pub. No.: US 2008/0170155 A1
(43) Pub. Date: Jul. 17, 2008

(54) BUFFER FOR PLAYBACK OF CLOSED CAPTIONING FROM TRANSMITTED PROGRAMS

(75) Inventors: STEVEN L. COOPER, WHITESTOWN, IN (US); KHELAN MODI, FISHERS, IN (US); MARK A. NIERZWICK, BROWNSBURG, IN (US)

Correspondence Address: SHIMOKAJI & ASSOCIATES, P.C., 8911 RESEARCH DRIVE, IRVINE, CA, 92618, US

(73) Assignee: TTE TECHNOLOGY, INC., INDIANAPOLIS, IN (US)

(21) Appl. No.: 11/677,150

(22) Filed: Feb. 21, 2007

(30) Foreign Application Priority Data
Jan. 11, 2007 (CN) 200710072926.1

(51) Int. Cl. H04N 5/445

(52) U.S. Cl. 348/564; 348/E05.102

(57) ABSTRACT

A television may be equipped with a closed captioning (CC) buffer for storing CC data received from, for example, cable, satellite or terrestrial broadcasts. A user may operate a remote control to move forward and reverse through the CC buffer to display CC data that the user may have a desire to review.

This application claims foreign priority under 35 USC 119(a)-(d) to Chinese Patent Application 200710072926.1, filed on Jan. 11, 2007, the disclosure of which is herein incorporated by reference in its entirety.

### BACKGROUND OF THE INVENTION

The present invention relates to closed captioning playback systems and methods, and more specifically, to closed captioning systems and methods that may store closed captioning data and allow for replay thereof.

Closed captioning (CC) text is available on many television and cable programs, as well as for pre-recorded media such as DVD and VHS. Close captioning is primarily used for the hearing impaired, but is also useful for other purposes. CC frequently provides additional information that either cannot be heard due to sound mixing problems or is simply missing from the audio-visual material. For the pre-recorded media, it is possible to replay a given scene with the closed captioning turned on to obtain this information, but for live cable or broadcast programs, this is not an option except in a personal video recorder (PVR) type product, which stores all the incoming content for a recorded program.

For an unrecorded cable or terrestrial broadcast of a television program in a standard television without PVR capabilities (a standard television), it is only possible to view the CC that is associated with the material that is currently playing. It would sometimes be useful to have the ability to replay the CC data. A PVR requires a great deal of storage space, usually in the form of a hard disk drive, to store the compressed, digitized, audio-visual material and its associated CC data. It would be impractical to store more than a few seconds of this data in a typical embedded television environment, which has no external storage capabilities and little extra RAM available.

One possible solution to the problem of not being able to review past CC data has been disclosed in U.S. Patent Publication No. 20030169234A1. This publication describes a remote control system having a display thereupon. The remote control may also include a remote receiver responsive to the CC data of the linked device (a television, for example). A data processor in the remote control may include memory for storing CC text. The stored CC text may then be reviewed, paused, reversed and the like. This solution, however, requires a specially designed remote control for receiving sent CC data, a specially designed television for sending remote control data, and a remote with a display, adding to the overall cost and complexity of the system to the consumer.

As can be seen, there is a need for a system and method for storing and reviewing CC data without requiring additional hardware that would add to the cost and complexity of the television.

### SUMMARY OF THE INVENTION

In one aspect of the present invention, an appliance comprises a closed captioning (CC) processor for receiving CC data transmitted to the appliance; a CC buffer for storing CC data; and a display for displaying the CC data, wherein the CC buffer may store at least 5 minutes of CC data; and wherein a user may reverse and forward through the CC data stored in the CC buffer.

In another aspect of the present invention a method for reviewing closed captioning (CC) data comprises pressing a rewind button on a remote control at least once to move in reverse through CC data stored in a CC buffer.

According to a further aspect of the present invention, a method storing closed caption (CC) data in an appliance and making the stored CC data available for later review comprises storing received CC data into a CC buffer to provide stored CC data; and optionally viewing one of: stored CC data in a reverse direction; stored CC data in a forward direction that is not in real time; and real time CC data.

These and other features, aspects and advantages of the present invention will become better understood with reference to the following drawings, description and claims.

### BRIEF DESCRIPTION OF THE DRAWINGS

FIG. 1 is a schematic view of a closed captioning storage and reviewing system according to an embodiment of the present invention; and

FIG. 2 is a flow chart showing a method according to an embodiment of the present invention.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

The term “appliance” as used herein may refer to any electronic equipment that may display programming having closed captioning (“CC”) data. For example, an “appliance” may include a television, a monitor or the like.

The term “real time” as used herein may refer to CC data associated with a particular television program that is being displayed. When CC data is being shown in “real time”, the CC data directly corresponds to the action and sounds associated with the displayed program being shown at that time. In other words, the CC data is being displayed as it was originally sent by the broadcaster in the data stream.

Briefly, the present invention provides a system and method for storing CC data from a cable or terrestrial broadcast program in a random access memory (RAM)/non-volatile memory (NVM) buffer for possible playback by the user. The systems and methods of the present invention may be useful in, for example, television broadcasts where CC data is transmitted along with the audio/visual signal.

With conventional CC systems, only two to three lines of CC text may be available for viewing at any particular time. Once those two to three lines of text passes, CC data associated with the next portion of the program replaces the two or three lines of CC data, thereby not permitting recall of the previously displayed two or three lines of CC data. A PVR may be used to save CC data along with the audio and visual portions of a broadcast. The PVR may also allow for rewinding of the program to review CC data. However, this technology requires costly hard drives for storage that may need repair or replacement by the user. In contrast, the systems and methods of the present invention may permit a user to review the previously displayed CC data without requiring costly storage devices such as hard drives.

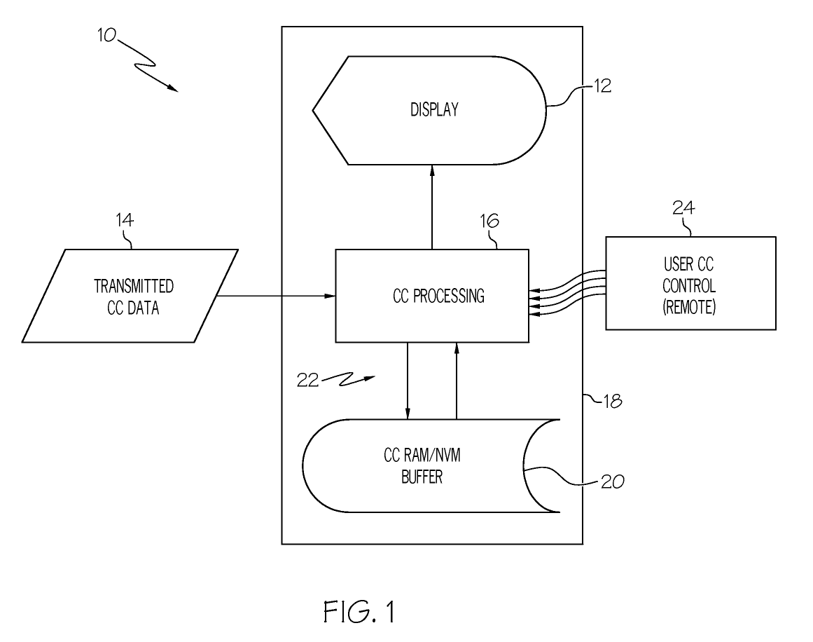

Referring to FIG. 1, there is shown a schematic view of a CC storage and reviewing system 10 according to an embodiment of the present invention. CC storage and reviewing system 10 may include a display 12 for viewing the program, including CC data 14. The CC data 14 may be transmitted, for example, via cable, satellite or terrestrial broadcast to a CC processor 16 located in an appliance 18, such as a television. A CC processor 16 may be linked with a CC RAM/NVM buffer 20 into which CC data 14 may be stored. The CC RAM/NVM buffer 20 may use conventional solid state memory to store CC data 14 sent to it via the CC processor 16. Double arrows 22 may be used to show the link between the CC RAM/NVM buffer 20 and the CC processor 16 because CC data may be sent from the CC processor 16 when storing CC data into the CC RAM/NVM buffer 20, and CC data may be sent to the CC processor 16 when retrieving stored CC data from the CC RAM/NVM buffer 20. A user may then access the stored CC data by using a remote control 24 to request a particular portion of the stored CC data be displayed.

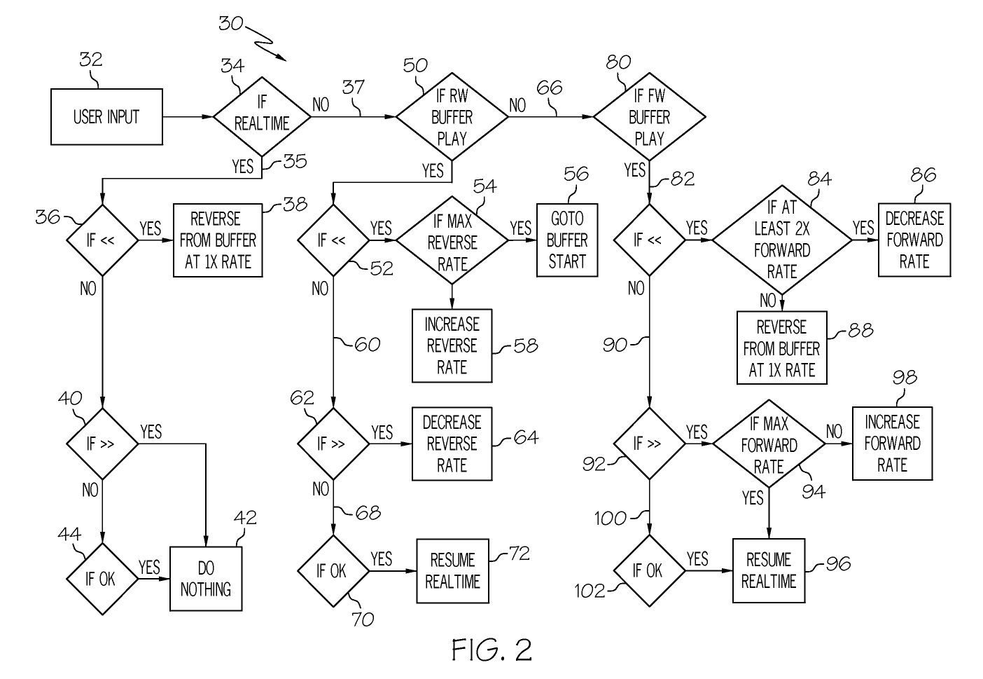

Referring now to FIG. 2, there is shown a flow chart describing a method 30 according to one embodiment of the present invention. The method 30 may be generally described as a method of viewing and reviewing CC data on an appliance, such as television 18. User input may be received at a step 32, wherein the user input may be received from, for example, the user's remote control 24 (see FIG. 1). The user input may be one of three different choices. The user may either choose to (1) scroll the display of CC data in reverse through buffered CC data, (2) scroll the display of CC data forward through the buffered CC data or (3) return from the display of buffered CC data to real time display of the CC data.

The description below describes in further detail one embodiment of the present invention wherein the CC processor 16 first determines whether the CC data is being displayed in real time (step 34). If CC data is being displayed in real time, then the method follows path 35. If CC data is not being displayed in real time, then the method 30 follows path 37 to then whether the CC data is being played from the CC buffer in a reverse direction (step 50), or whether the CC data is being displayed from the CC buffer in a forward direction (step 80). From this determination, the CC processor 16 then determines which of the above described three choices (scroll in reverse, scroll forward, or return to real time) were made by the user and takes the appropriate action as described in further detail below.

The decision step 34 queries whether the CC data is currently being shown in real time. If the CC data is currently being shown in real time, then a decision step 36 checks to see if a rewind button (not shown) has been pressed. Rewind button may be one of several buttons available on the user's remote control 24. For example, rewind button may be a left arrow.

If the rewind button has been pressed, then a step 38 of reversing the CC data that is displayed on the screen is performed. In other words, what is displayed on the display with respect to CC data is scrolled in reverse through the CC buffer, typically at 1 times the forward rate by retrieving data from the CC RAM/NVM buffer 20. In other words, the CC data may be scrolled backwards at a rate that is the same as the regular forward rate.

If the rewind button has not been pressed, then a decision step 40 checks to see if a forward button (not shown) has been pressed. Forward button may be one of several buttons available on the user's remote control 24. For example, forward button may be a right arrow.

If the forward button has been pressed, then nothing is done in step 42. This is because, when displaying CC data in real time, there is no CC data in the buffer available to move forward through. However, as described below, if the user is not displaying CC data in real time and the forward button has been pressed, then the user may be permitted to scroll through the buffered CC data at a selected forward speed.

If the forward button has not been pressed, the CC processor 16 may check to see if an OK button (not shown) has been pressed in a decision step 44. The OK button may, for example, labeled as “OK” or “Select” on the remote control.

Generally, the OK button may be used to return the display of CC data to real time. However, if the OK button has been pressed while in real time, then nothing is done in the step 42. If the OK button has not been pressed, then the CC processor 1 6 awaits further input from the user.

Returning to the decision step 34, if the CC data is not being shown in real time, then one of two states can be present. Either (1) the displayed CC data is being played in reverse through the buffer (thereby allowing a user to view in reverse previously displayed CC data) or (2) the displayed CC data is being played forward through the buffer (thereby allowing a user to either review buffered CC data at the speed originally sent by the broadcast or to move forward at a faster than normal rate through buffered CC data to eventually reach real time viewing).

If a decision step 50 determines that the displayed CC data is being played in reverse through the buffer, then one of three inputs may be received from the CC processor 1 6. The three inputs are similar to the situation when in real time as described above, i.e., the user may press the rewind button, the forward button, or the OK button.

If, at a decision step 52, it is determined that the rewind button has been pressed, then a decision step 54 may be performed to determine if the maximum rewind speed of reverse viewing of the buffered CC data has been reached. If the maximum rewind speed has already been reached when the rewind button is pressed, then the CC processor 16 may perform a step 56 to rewind the displayed CC data to the beginning of the buffer. If the maximum rewind speed has not already been reached when the rewind button is pressed, then the CC processor 16 may perform a step 58 to increase the reverse speed.

If the rewind button has not been pressed at the decision step 52, then the method 30 continues in path 60 to determine if the forward button was pressed by the user.

If, at a decision step 62, it is determined that the forward button has been pressed, then the reverse rate may be decreased at a step 64 to the next slower reverse rate. If the reverse rate was at the first user selectable reverse speed (i.e., the slowest available reverse speed), then depressing the forward button may return the CC data to the regular forward speed at that point in the CC data buffer. When this is the case, the decision step 50 may determine that the displayed CC data is no longer being played in reverse through the buffer and the method 30 may continue along path 66.

If the forward button has not been pressed at decision step 62, then the method 30 continues in path 68.

If, at decision step 70, it is determined that the OK button has been pressed, real time display of CC data may be performed in a step 72. In other words, when moving in reverse through the CC data, pressing the OK button may jump the user to real time CC data display.

If a decision step 50 determines that the displayed CC data is not being played in reverse through the buffer, then the method 30 continues in path 66 to a decision step 80 which may determine if the buffer is playing forward. Similar to the situation when in real time or when playing in reverse from the buffer as described above, the user may press the rewind button, the forward button, or the OK button.

If, at a decision step 82, it is determined that the rewind button has been pressed, then a further decision step 84 may be performed to determine if the speed of forward play of CC data from the buffer is faster (e.g., at least two times) than the regular speed (in other words, the CC data is being displayed from the buffer at a speed greater than it was originally displayed in the original programming). If this is the case, then the CC processor 16 may perform a step 86 to decrease the forward speed that the CC data is displayed. If the rate of forward play of CC data from the buffer is at one times the regular speed (in other words, the CC data is being displayed from the buffer at a speed as it was originally displayed in the original programming), then the CC processor 16 may perform a step 88 to display data from the CC buffer in reverse at the slowest reverse speed (typically, one times the original display speed).

If the rewind button has not been pressed at the decision step 82, then the method 30 continues in path 90.

If, at a decision step 92, it is determined that the forward button has been pressed, then a further decision step 94 may be performed to determine if the rate of forward play of CC data from the buffer is at the maximum rate. If the maximum forward speed has already been reached when the forward button has been pressed, then the CC processor 16 may perform a step 96 to jump the displayed CC data to the end of the buffer (i.e., back to real time). If the maximum forward speed has not already been reached when the forward button is pressed, then the CC processor 1 6 may perform a step 98 to increase the forward rate of display of the CC data.

If the forward button has not been pressed at decision step 92, then the method 30 continues in path 100.

If, at decision step 1 02, it is determined that the OK button has been pressed, real time display of CC data may be performed in step 96. In other words, when moving in forward through the CC data, the OK button may jump the user to the real time CC data display. If the OK button has not been pressed, then the CC processor 1 6 may await further input from the user.

When the forward/rewind buttons are pressed, there may be, for example, from 1 to 7 forward/rewind speeds selectable by the user; typically, there may be from about 3 to about 5 forward/rewind speeds selectable by the user. The forward/reverse speeds may be, for example, at one times the original display speed, two times the original display speed, four times the original display speed, eight times the original display speed, and the like. If, for example, there are 5 reverse speeds selectable by the user, the user may depress the rewind button 6 times to quickly move to the end of the CC data buffer (the first five times may incrementally increase the reverse rate and the final time (the sixth time) may jump to the beginning of the buffer).

The above described method of the present invention may be used by a user in a variety of ways, depending on the user's preference. For example, a user may press the rewind button in real time to scroll backwards through the buffered CC data, reviewing the CC data in reverse. Once the user views what they may have missed, the user may then press the OK button to return to real time.

Alternatively, other users may desire to press the rewind button in real time to scroll backwards through the buffered CC data to a point past (i.e., earlier in time) the point of interest that the user wishes to review. At that point, the user may press the forward button to permit forward scrolling of the buffered CC data on the screen. One advantage of this aspect of the method 30 of the invention is that the user may view the desired CC data in the forward direction, rather than in reverse. As described in the above paragraph, once the user views what they may have missed, the user may then press the OK button to return to real time.

It should be understood, of course, that the foregoing relates to exemplary embodiments of the invention and that modifications may be made without departing from the spirit and scope of the invention as set forth in the following claims.

We claim:

1. An appliance comprising:
a closed caption (CC) processor for receiving CC data transmitted to the appliance;
a CC buffer for storing CC data; and
a display for displaying the CC data;
wherein the CC buffer may store at least about 5 minutes of CC data; and
wherein a user may reverse and forward through the CC data stored in the CC buffer.

2. The appliance according to claim 1, wherein the appliance is a television.

3. The appliance according to claim 1, wherein the CC buffer is at least one of a random access memory-based buffer and a non-volatile memory-based buffer.

4. The appliance according to claim 1, further comprising a remote control adapted to allow the user to reverse through the CC data in the CC buffer, move forward through the CC data in the CC buffer, and return to real time display of the CC data.

5. The appliance according to claim 1, wherein the CC buffer may store from about 15 minutes to about 1 hour of CC data.

6. The appliance according to claim 1, wherein the user may select from about 3 to about 7 speeds for moving reverse through the CC data in the CC buffer and for moving forward through the CC data in the CC buffer.

7. The appliance according to claim 1, wherein the CC data is transmitted to the television via a cable program, a terrestrial broadcast program, or a satellite broadcast program.

8. A method for reviewing closed caption (CC) data, the method comprising pressing a rewind button on a remote control at least once to move in reverse through CC data stored in a CC buffer.

9. The method according to claim 8, further comprising:
moving in reverse past desired CC data; and
pressing a forward button to affect forward display of CC data from the CC buffer.

10. The method according to claim 9, further comprising pressing an OK button after reviewing the desired CC data to return to real time display of CC data.

11. The method according to claim 8, wherein pressing the rewind button once reverses through the CC data at one times an original speed the CC data was displayed.

12. The method according to claim 11, wherein pressing the rewind button additional times increases the speed in which the CC data is moved through in reverse.

13. The method according to claim 12, wherein, once a maximum reverse speed is selected, pressing the rewind button one additional time beyond that for the selection of the maximum reverse speed causes the CC data to be displayed from the beginning of the buffer.

14. The method according to claim 9, wherein pressing the forward button additional times increases the speed in which the CC data is moved through in a forward direction.

15. The method according to claim 14, wherein, once a maximum forward speed is selected, pressing the forward button one additional time beyond that for the selection of the maximum forward speed causes the CC data to be displayed in real time.

16. A method storing closed caption (CC) data in an appliance and making the stored CC data available for later review, the method comprising:
storing received CC data into a CC buffer to provide stored CC data; and
optionally viewing one of:
stored CC data in a reverse direction;
stored CC data in a forward direction that is not in real time; and
real time CC data.

17. The method according to claim 16, wherein the appliance is a television.

18. The appliance according to claim 16, wherein the CC buffer is at least one of a random access memory-based buffer and a non-volatile memory-based buffer.

19. The appliance according to claim 16, wherein the user may select from about 3 to about 7 speeds for viewing the stored CC data in the reverse direction and for viewing the stored CC data in the forward direction.

20. The appliance according to claim 16, wherein the CC data is transmitted to the television via a cable program, a terrestrial broadcast program, or a satellite broadcast program.
